(19) United States
(12) Patent Application Publication
(10) Pub. No.: US 2007/0279933 A1
(43) Pub. Date: Dec. 6, 2007

(54) EDGE-TYPE BACKLIGHT MODULE AND MANUFACTURING METHOD THEREOF

(76) Inventors: Tzeng-Ke Shiau, Hsinchu (TW); Ching-Shiang Li, Hsinchu (TW); Teng-Chao Hou, Hsinchu (TW); Wen-Bin Chou, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/696,195

(22) Filed: Apr. 4, 2007

(30) Foreign Application Priority Data
Jun. 2, 2006 (TW) 095209611

(51) Int. Cl. F21V 7/04

(52) U.S. Cl. 362/606; 362/618; 362/627

(57) ABSTRACT

An edge-type backlight module includes a light source, a light guide plate installed on a lateral side of the light source, and a brightness enhancement film disposed above the light guide plate. The brightness enhancement film includes a plurality of micro-structures on a bottom surface connected to a top surface of the light guide plate in an adhesion manner or a hot melt manner.

### BACKGROUND OF THE INVENTION

1. Field of the Invention

The present invention relates to an edge-type backlight module, and more particularly, to an edge-type backlight module with a brightness enhancement film combined with a light guide plate closely.

2. Description of the Prior Art

Please refer to FIG. 1. FIG. 1 is a schematic diagram of a conventional edge-type backlight module 10. The edge-type backlight module 10 includes a light guide plate 12, and a light source 14 installed on a lateral side of the light guide plate 12. The light source 14, for example, can be a cold cathode fluorescent lamp (CCFL). The edge-type backlight module 10 further includes a brightness enhancement film 16 installed above the light guide plate 12. A plurality of micro-structures 18 is disposed on the bottom surface of the brightness enhancement film 16. The light guide plate 12 is a transparent and parallel plate. The light emitted from the light source 14 repeats total reflection inside the light guide plate 12. The brightness enhancement film 16 combines with the light guide plate 12 by gravity or static electricity so that the plurality of micro-structures 18 disposed on the bottom of the brightness enhancement film 16 is in close contact with the light guide plate 12 without any air interface. The light refracts from the light guide plate 12 to the brightness enhancement film 16 via the contact areas between the light guide plate 12 and the plurality of micro-structures 18. The protruding shape of the micro-structure 18 can be designed so that an angle of the light emitting out of the brightness enhancement film 16 can be converged for increasing brightness within a range of a view angle.

However, the brightness enhancement film 16 combines with the light guide plate 12 only by gravity or static electricity in the conventional art. It cannot ensure that every micro-structure 18 is in contact with the light guide plate 12 or the contact areas thereof are uniform. Because the contact areas between micro-structures 18 and the light guide plate 12 are not uniform, the angles of the light emitting out of the brightness enhancement film 16 cannot be uniform. Therefore, the uniformity of brightness of the edge-type backlight module 10 in the conventional art is decreased and the product yield of the edge-type backlight module 10 can not be enhanced.

### SUMMARY OF THE INVENTION

It is therefore an objective of the claimed invention to provide an edge-type backlight module for solving the above-mentioned problem.

According to one embodiment of the claimed invention, an edge-type backlight module includes a light source, a light guide plate installed on a lateral side of the light source, and a brightness enhancement film disposed above the light guide plate. The brightness enhancement film includes a plurality of micro-structures on a bottom surface adhered to a top surface of the light guide plate.

According to another embodiment of the claimed invention, an edge-type backlight module includes a light source, a light guide plate installed on a lateral side of the light source, and a brightness enhancement film disposed above the light guide plate. The brightness enhancement film includes a plurality of micro-structures on a bottom surface connected to a top surface of the light guide plate in a hot melt manner.

According to another embodiment of the claimed invention, a method for manufacturing an edge-type backlight module is disclosed. The method includes following steps: (a) forming a plurality of micro-structures on a bottom surface of a brightness enhancement film; and (b) adhering the plurality of micro-structures of the brightness enhancement film to a top surface of a light guide plate.

According to another embodiment of the claimed invention, a method for manufacturing an edge-type backlight module is disclosed. The method includes following steps: (a) forming a plurality of micro-structures on a bottom surface of a brightness enhancement film; and (b) connecting the plurality of micro-structures of the brightness enhancement film to a top surface of a light guide plate in a hot melt manner.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a conventional edge-type backlight module.

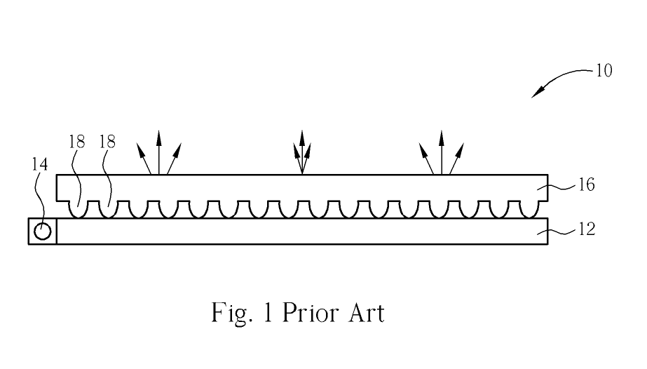

FIG. 2 is a schematic diagram of an edge-type backlight module according to an embodiment of the present invention.

FIG. 3 is a flowchart of manufacturing the edge-type backlight module shown in FIG. 2 according to an embodiment of the present invention.

FIG. 4 is a schematic diagram of an edge-type backlight module according to another embodiment of the present invention.

FIG. 5 is a flowchart of manufacturing the edge-type backlight module shown in FIG. 4 according to an embodiment of the present invention.

FIG. 6 is a schematic diagram of an edge-type backlight module according to another embodiment of the present invention.

FIG. 7 is a schematic diagram of an edge-type backlight module according to another embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

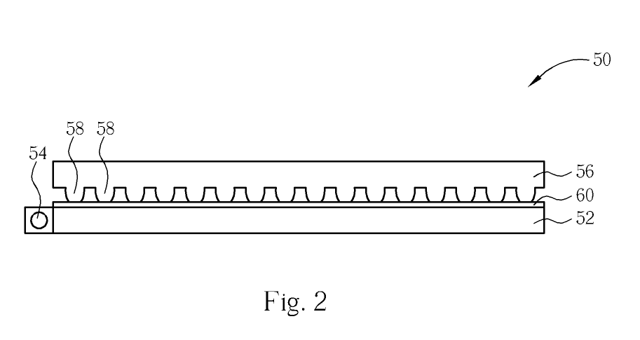

Please refer to FIG. 2. FIG. 2 is a schematic diagram of an edge-type backlight module 50 according to an embodiment of the present invention. The edge-type backlight module 50 includes a light guide plate 52. The light guide plate 52 can be, for example, in a parallel structure, a wedge structure, or a double wedge structure. The edge-type backlight module 50 further includes a light source 54 installed on a lateral side of the light guide plate 52. The light source 54 can be, for example, a cold cathode fluorescent lamp (CCFL). The edge-type backlight module 50 further includes a brightness enhancement film 56 disposed above the light guide plate 52. A plurality of micro-structures 58 is disposed on a bottom surface of the brightness enhancement film 56. Each of the micro-structures 58 can be a symmetric protruding structure, such as a spherical structure, a parabolic structure, or a multi-curve structure. Each of the micro-structures 58 also can be an asymmetric protruding structure, such as an asymmetric spherical structure, an asymmetric parabolic structure, or an asymmetric multi-curve structure. Furthermore, each of the micro-structures 58 can be a tapering structure, such as a conoid structure or a pyramid structure. Each of the micro-structures 58 also can be an alpine structure or a W-shaped structure. The plurality of micro-structures 58 can be formed on the bottom surface of the brightness enhancement film 56 in a regular arrangement, a serial arrangement, or a random arrangement.

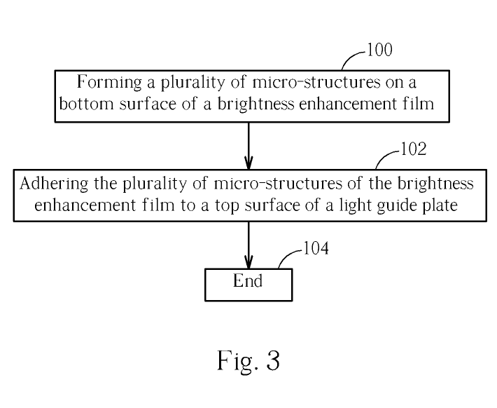

Please refer to FIG. 3. FIG. 3 is a flowchart of manufacturing the edge-type backlight module 50 shown in FIG. 2 according to an embodiment of the present invention. The method includes following steps:

Step 100: forming the plurality of micro-structures 58 on the bottom surface of the brightness enhancement film 56.

Step 102: adhering the plurality of micro-structures 58 on the bottom surface of the brightness enhancement film 56 to a top surface of the light guide plate 52.

Step 104: end.

The plurality of micro-structures 58 on the bottom surface of the brightness enhancement film 56 is adhered to the top surface of the light guide plate 52. The edge-type backlight module 50 further includes an adhesive layer 60 adhered to the top surface of the light guide plate 52 and the plurality of micro-structures 58 of the brightness enhancement film 56 so as to integrate the brightness enhancement film 56 with the light guide plate 52 and ensure every micro-structure 58 is in contact with the light guide plate 52 uniformly, that is, all contact areas between the plurality of micro-structures 58 and the light guide plate 52 are substantially uniform. The adhesive layer 60 can be, for example, made of UV adhesive or thermosetting adhesive. As shown in FIG. 2, because every micro-structure 58 is in contact with the light guide plate 52 uniformly, the angles of the light emitting out of the brightness enhancement film 56 can be uniform so as to increase uniformity of the brightness of the edge-type backlight module 50 and the product yield of the edge-type backlight module 50.

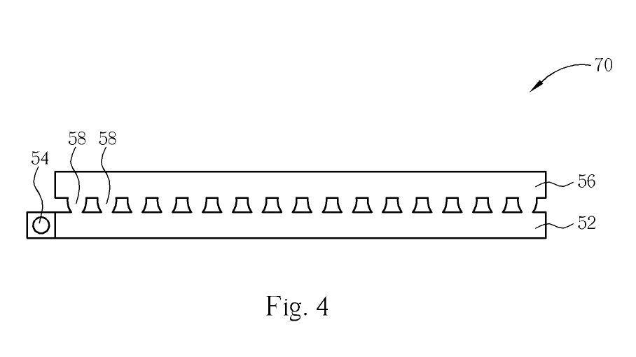

Please refer to FIG. 4. FIG. 4 is a schematic diagram of an edge-type backlight module 70 according to another embodiment of the present invention. The edge-type backlight module 70 includes a light guide plate 52, a light source 54 installed on the lateral side of the light guide plate 52, and the brightness enhancement film 56 disposed above the light guide plate 52. The plurality of micro-structures 58 is disposed on the bottom surface of the brightness enhancement film 56.

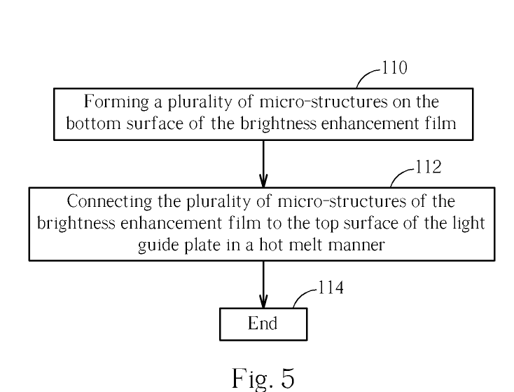

Please refer to FIG. 5. FIG. 5 is a flowchart of manufacturing the edge-type backlight module 70 shown in FIG. 4 according to an embodiment of the present invention. The method includes following steps:

Step 110: forming a plurality of micro-structures 58 on the bottom surface of the brightness enhancement film 56.

Step 112: connecting the plurality of micro-structures 58 of the brightness enhancement film 56 to the top surface of the light guide plate 52 in a hot melt manner.

Step 114: end.

The difference between the edge-type backlight module 50 and the edge-type backlight module 70 is the way of the combination of the plurality of micro-structures 58 and the light guide plate 52. The plurality of micro-structures 58 on the bottom surface of the brightness enhancement film 56 of the edge-type backlight module 70 is connected to the top surface of the light guide plate 52 in the hot melt manner so as to integrate the brightness enhancement film 56 with the light guide plate 52 and ensure every micro-structure 58 is in contact with the light guide plate 52 uniformly, that is, all contact areas between the plurality of micro-structures 58 and the light guide plate 52 are substantially uniform. As shown in FIG. 4, because every micro-structure 58 is in contact with the light guide plate 52 uniformly, the angles of the light emitting out of the brightness enhancement film 56 can be uniform so as to increase uniformity of the brightness of the edge-type backlight module 70 and the product yield of the edge-type backlight module 70.

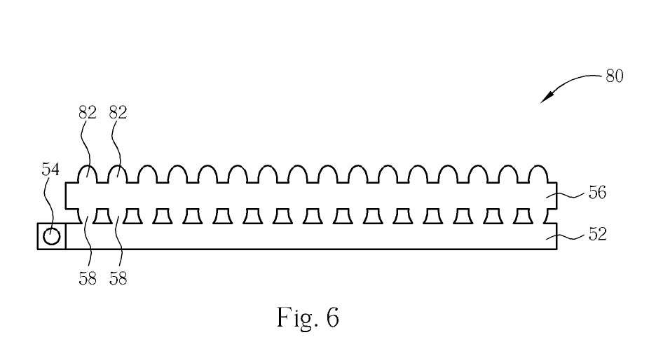

Please refer to FIG. 6. FIG. 6 is a schematic diagram of an edge-type backlight module 80 according to another embodiment of the present invention. The edge-type backlight module 80 includes a light guide plate 52, a light source 54 installed on the lateral side of the light guide plate 52, and a brightness enhancement film 56 disposed above the light guide plate 52. A plurality of micro-structures 58 disposed on the bottom surface of the brightness enhancement film 56 can be in connection with the top surface of the light guide plate 52 in an adhesion manner or a hot melt manner as mentioned above. A plurality of micro-structures 82 is disposed on a top surface of the brightness enhancement film 56 for concentrating light emitting out of the brightness enhancement film 56 within a range. In addition, the brightness enhancement film 56 can be transparent or embedded with medium particles for diffusing light.

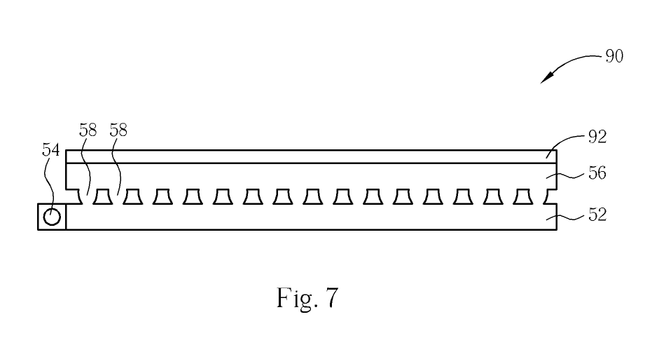

Please refer to FIG. 7. FIG. 7 is a schematic diagram of an edge-type backlight module 90 according to another embodiment of the present invention. The edge-type backlight module 90 includes the light guide plate 52, the light source 54 installed on the lateral side of the light guide plate 52, and the brightness enhancement film 56 disposed above the light guide plate 52. The plurality of micro-structures 58 disposed on the bottom surface of the brightness enhancement film 56 is in connection with the top surface of the light guide plate 52 in an adhesion manner or a hot melt manner as mentioned above. The edge-type backlight module 90 can further includes a diffuser 92 disposed above the brightness enhancement film 56 for diffusing light so as to increase uniformity of emitting light.

In contrast to the conventional edge-type backlight module, the edge-type backlight module of the present invention includes the plurality of micro-structures of the brightness enhancement film connected to the light guide plate closely and uniformly in an adhesion manner or a hot melt manner. Every micro-structure is in contact with the light guide plate uniformly, that is, all contact areas between the plurality of micro-structures and the light guide plate are substantially uniform. The angles of the light emitting out of the brightness enhancement film can be uniform so as to increase uniformity of the brightness of the edge-type backlight module and the product yield of the edge-type backlight module.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An edge-type backlight module comprising:
a light source;
a light guide plate installed on a lateral side of said light source; and
a brightness enhancement film disposed above said light guide plate, said brightness enhancement film comprising a plurality of micro-structures on a bottom surface adhered to a top surface of said light guide plate.

2. The edge-type backlight module of claim 1 further comprising an adhesive layer adhered to said top surface of said light guide plate and said plurality of micro-structures on said bottom surface of said brightness enhancement film.

3. The edge-type backlight module of claim 2 wherein said adhesive layer is made of UV adhesive or thermosetting adhesive.

4. The edge-type backlight module of claim 1 wherein each of said micro-structures is a symmetric protruding structure.

5. The edge-type backlight module of claim 4 wherein each of said micro-structures is a spherical structure or a parabolic structure.

6. The edge-type backlight module of claim 1 wherein each of said micro-structures is an asymmetric protruding structure.

7. The edge-type backlight module of claim 1 wherein each of said micro-structures is a tapering structure, an alpine structure, or a W-shaped structure.

8. The edge-type backlight module of claim 1 wherein said brightness enhancement film comprises a plurality of micro-structures on a top surface for concentrating light within a range.

9. The edge-type backlight module of claim 1 further comprising a diffuser disposed above said brightness enhancement film for diffusing light.

10. An edge-type backlight module comprising:
a light source;
a light guide plate installed on a lateral side of said light source; and
a brightness enhancement film disposed above said light guide plate, said brightness enhancement film comprising a plurality of micro-structures on a bottom surface connected to a top surface of said light guide plate in a hot melt manner.

11. The edge-type backlight module of claim 10 wherein each of said micro-structures is a symmetric protruding structure.

12. The edge-type backlight module of claim 111 wherein each of said micro-structures is a spherical structure or a parabolic structure.

13. The edge-type backlight module of claim 10 wherein each of said micro-structures is an asymmetric protruding structure.

14. The edge-type backlight module of claim 10 wherein each of the micro-structures is a tapering structure, an alpine structure, or a W-shaped structure.

15. The edge-type backlight module of claim 10 wherein said brightness enhancement film comprises a plurality of micro-structures on a top surface for concentrating light emitting out of said brightness enhancement film within a range.

16. The edge-type backlight module of claim 10 further comprising a diffuser disposed above said brightness enhancement film for diffusing light.

17. A method for manufacturing an edge-type backlight module, said method comprising:
(a) forming a plurality of micro-structures on a bottom surface of a brightness enhancement film; and
(b) connecting said plurality of micro-structures on said bottom surface of said brightness enhancement film to a top surface of a light guide plate in an adhesion manner or in a hot melt manner.

18. The method of claim 17 wherein step (b) comprises utilizing an adhesive layer to adhere to the said top surface of said light guide plate and said plurality of micro-structures on said bottom surface of said brightness enhancement film.

19. The method of claim 18 further comprising forming a plurality of micro-structures on a top surface of said brightness enhancement film for concentrating light emitting out of said brightness enhancement film within a range.
